(19) United States
(12) Patent Application Publication
(10) Pub. No.: US 2005/0280913 A1
(43) Pub. Date: Dec. 22, 2005

(54) System for securing recordings of digital data

(75) Inventors: Laurent Thorel, Arpajon (FR); Philippe Thorel, Vert-le-Petit (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: WMI Wellcom Multimedia et Internet, a corporation of France, Boulogne-Billancourt (FR)

(21) Appl. No.: 11/146,096

(22) Filed: Jun. 6, 2005

Related U.S. Application Data
(63) Continuation of application No. PCT/FR03/50159, filed on Dec. 11, 2003.

(30) Foreign Application Priority Data
Dec. 11, 2002 (FR) FR 02/15658

(51) Int. Cl. G11B 5/86

(52) U.S. Cl. 360/15

(57) ABSTRACT

A system for controlling copying including at least one physical support including a recording of digital data, a computer that reads and duplicates the physical support, and recordable duplication supports, wherein a format for recording information on the physical support is determined in such a manner as to inhibit duplication functionalities of the computer, and a device for modifying the computer to permit a conditional duplication of the physical supports such that duplication produces a recording different from an original recording that cannot be duplicated.

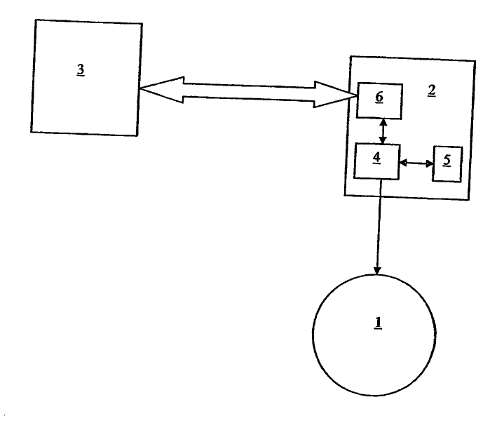

### RELATED APPLICATION

This is a continuation of International Application No. PCT/FR2003/050159, with an international filing date of Dec. 11, 2003 (WO 2004/055649, published Jul. 1, 2004), which is based on French Patent Application No. 02/15658, filed Dec. 11, 2002.

### FIELD OF THE INVENTION

This invention relates to securing recordings of digital data for combating improper copying. It relates more particularly to the management of rights of intellectual property pertaining to multimedia compact disks (audio, video, rich media and the like) of DVD's and supports for software of video games.

### BACKGROUND

Various solutions are known that permit the protection of digital data recorded on a disk, especially an optical disk, against being copied.

U.S. Pat. No. 6,425,098 describes a process permitting the protection of data recorded on an original recording support from being copied by a device for reading non-authorized data. The data is coded in conformity with norm 908 of the International Electronic Commission. Part of the coded data is modified to permit the introduction of a change in sub-code Q channel of the data in such a manner that the modified data is incompatible with the application of norm 908 used in the data reading device, but does not prevent reading data after it has been recorded. The data, comprising the modified data, is registered on the original recording support, an application that permits the reading of registered data, functioning while substantially not affected by the changes made to the data, but a substantially irreparable error is produced during the non-authorized copying of the original recording support.

WO 02/75735 describes a compact disc with copy protection that is configured in such a manner as to be able to supply access to digital musical content subject to a protocol of electronic rights for computer users while preventing the digital audio extraction of the digital musical content, which could be used for recopying and possibly propagating illegal copies of the content. This compact disc with copy protection preferably comprises a first session that comprises the standard digital audio content in a format that can be read by a classic reader of compact discs. It also comprises a second session that is configured in such a manner as to supply a computer user with access to an alternative form of the same digital audio content, but which is subjected to a protocol of electronic rights such as a protocol requiring a key for reading or copying the audio content. Moreover, this disk is provided with a copy protection system that prevents a computer user from identifying the standard digital audio content as such and that orients the computer toward the second session and the alternative audio content. This copy protection program is preferably a configuration of control data that is situated in the blank zone at the start of the session of the compact disk.

EP 1 049 087 discloses a process for recording information. When data is recorded from media A to media B, if the recording is carried out in the form of a transfer, the information about the rights of A can lose or not lose the reproduction right. At the same time, the data recorded on A be deleted or irreversibly scrambled. EP '087 also describes a system for the payment of rights. However, it only concerns modification of the reproduction rights without considering the problem of the possibility of reproduction. Thus, anyone who possesses a media with the right of reproduction can reproduce it. This problem is one of the great disadvantages of the prior art.

Moreover, the prior art does not permit the conditions of use, that can vary from one country to the other, to be dynamically managed. Certain countries grant holders the right to authorize one copy for private usage. Other countries authorize one or more copies for purposes of backup only. Technical solutions radically preventing any copying are illegal for this reason or in any case do not conform to legal requirements.

### SUMMARY OF THE INVENTION

This invention relates to a system for controlling copying including at least one physical support including a recording of digital data, a computer that reads and duplicates the physical support, and recordable duplication supports wherein a format for recording information on the physical support is determined in such a manner as to inhibit duplication functionalities of the computer, and a device for modifying the computer to permit a conditional duplication of the physical supports such that duplication produces a recording different from an original recording that cannot be duplicated.

### BRIEF DESCRIPTION OF THE DRAWING

The Drawing shows a schematic view of a system in accordance with aspects of the invention.

### DETAILED DESCRIPTION

This invention provides a solution that respects the two apparently contradictory constraints:
interdiction of non-authorized copies, and
respect of regulatory constraints relative to the exceptions of private copying or backup.

To this end the invention relates in one way to a system of using information supports permitting the control of copying, comprising:
physical supports comprising a recording of digital data,
standard computer equipment for reading and duplicating such a physical support, and
recordable duplication supports,
wherein the format for recording information on the physical support is determined in such a manner as to inhibit duplication functionalities of standard computer equipment,
the system comprises means for modifying standard computer equipment to permit a conditional duplication of the physical supports, and
the duplication produces a recording different from the original recording that cannot be duplicated.

The original physical support is, e.g., an optical or magneto optical support:
a CD,
a CD-R,
a DVD and
a DVD-R.

The original physical support can also be a removable mass storage device, e.g., a memory card of the MMC, flash or memory stick type.

The original physical support as well as the physical support of the duplication comprise:
a single ROM session or
an audio session and a ROM session.

The computer equipment advantageously comprises a means for tattooing duplicated recordings, e.g., of the watermark type. The computer equipment also preferably comprises a means for generating a digital imprint of the duplicated recordings, e.g., of the fingerprint type.

The computer equipment preferably comprises a duplication means that analyzes the characteristics of the recording and initiation of the procedure for the verification of the conditions of duplication and control of the etching of protected copies only when the conditions of duplication associated with the characteristics of the recording are valid.

Moreover, the computer equipment advantageously comprises a control means comprising a base of identifiers and authorizations associated with the identifiers, which verification procedure comprises verifying the state of the authorizations corresponding to the identifier.

The identifiers may be identifiers of at least a part of the original support. The identifiers may also be identifiers of the proprietary user of the original support. The identifier of the proprietary user of the original physical support can be of the electronic signature, electronic address or mail type.

The updating information preferably modifies the state of an authorization computer.

The identifier of the original support may be a single (unique) identifier associated with the physical support. The identifier of the original support may also be an identifier of the computer equipment that performed the first duplication.

The verification procedure may be performed automatically with the computer equipment transmitting information for updating the authorizations associated with the identifier after duplication directly to the server.

The verification procedure need not be performed automatically, but rather the proprietary user of the original support transmits a key for the updating of authorizations.

This key is preferably an identifier of the original support, an identifier of the proprietary user of the original support or a combination of the two identifiers.

The invention will be better understood from a reading of the following description, that refers to a non-limiting exemplary embodiment.

The Drawing shows an example of architecture for implementing the invention.

The invention implements a recording support, a CD 1, in the example. The digital data is registered with a non-standard coding format whether sound files or digital videos or even computer programs or associations of several files of different natures are involved. In particular, double-session CDs or DVDs with an audio or audio-visual session and a ROM session are concerned. CDs with additional (bonus) contents in high-compression video are also concerned.

It is understood that the CD or DVD can have a single ROM session. For this, the preparation of the matrix for pressing disks is realized with an encrypter specific for the operator of the broadcasting system. The disk is read with customary equipment comprising an appropriate reader and computer equipment 2, e.g., a microcomputer or a dedicated reader.

The equipment comprises in a known manner software or hardware means 3 for processing signals supplied by reader 2.

The decompression algorithms do not permit restitution of recorded information on account of the specific encryption. Other solutions for inhibiting the operation of the standard player 3 can be provided.

Application software 4, e.g., a specific plug-in or player is recorded on the computer equipment.

It is this application software that performs the operation of the signals and the restitution of the contents.

The disk copy is classically made with the recording and reproduction functions of player 3. The latter are not operative on account of the difference between the encryption format of the original CD 1 and the standard one of the player 3.

Application software 4 comprises a duplication function actuatable only when a condition is verified. This condition is constituted, e.g., by the number of prior duplications or by the profile of the requesting party or even by a financial condition.

To this end, the application software interrogates the state of a recorded or calculated marker associated with an identifier of the CD being used. This marker can be recorded or calculated on a server 5 with which the equipment communicates via a communication interface 6 or also on a support associated with the CD, e.g., a memory card, or a personalized rewritable recording support. It could also be a recordable layer of the CD itself.

This mode of automatic communication with the server for the delivery of copy authorizations can be called “direct mode”. However, there is, in addition, an indirect delivery mode in which the user must self-identify by sending a proprietary user identifier. This dispatch can then be an SMS or a mailing. It then delivers an actuation key constituted of its identifier and that of its product and receives in return, in the case of a valid identification, the rights for private copying.

Furthermore, it can also be envisioned that the recorded marker that interrogates the application software for delivering copy rights is not associated with the CD during the course of use, but rather with the proprietary user of the CD itself. Thus, the copyrights could be granted to the physical person and not only to a machine.

One can then, of course, use a function marker of the two identifiers, of the proprietary user of the CD and of the CD.

The application software can also comprise, for reasons of security and traceability, means for marking the copy. These means are of a known type and are, e.g., means for tattooing by watermarking or digital imprint by fingerprint. Once the copy is marked in this manner, it will then be possible to recognize in accordance with the marking type the user who made the copy or the original support that served for the copying.

Note that watermarking is satisfactory for the traceability of the copying since it is persistent even in analog mode.

Although this invention has been described in connection with specific forms thereof, it will be appreciated that a wide variety of equivalents may be substituted for the specified elements described herein without departing from the spirit and scope of this invention as described in the appended claims.

1. A system for controlling copying comprising:
at least one physical support comprising a recording of digital data,
a computer that reads and duplicates the physical support, and
recordable duplication supports,
wherein a format for recording information on the physical support is determined in such a manner as to inhibit duplication functionalities of the computer, and
a device for modifying the computer to permit a conditional duplication of the physical supports such that duplication produces a recording different from an original recording that cannot be duplicated.

2. The system according to claim 1, wherein the original physical support is a CD.

3. The system according to claim 1, wherein the original physical support is a CD-R.

4. The system according to claim 1, wherein the original physical support is an optical support.

5. The system according to claim 1, wherein the original physical support is a DVD.

6. The system according to claim 1, wherein the original physical support is a removable mass storage device.

7. The system according to claim 6, wherein the removable mass storage device is a memory card.

8. The system according to claim 1, wherein the original physical support comprises digitized audio information.

9. The system according to claim 1, wherein the original physical support comprises digitized video information.

10. The system according to claim 1, wherein the original physical support comprises computer programs.

11. The system according to claim 1, wherein the original physical support has a single ROM session.

12. The system according to claim 1, wherein the original physical support has an audio session and a ROM session.

13. The system according to claim 1, wherein the physical support of the duplication has a ROM session and an audio session.

14. The system according to claim 1, wherein the physical support of the duplication has a single ROM session.

15. The system according to claim 1, wherein the computer comprises a device for tattooing duplicated recordings.

16. The system according to claim 15, wherein the device for tattooing is of the watermarking type.

17. The system according to claim 1, wherein the computer comprises a generator of a digital imprint of duplicated recordings.

18. The system according to claim 17, wherein the imprints are of the fingerprint type.

19. The system according to claim 1, wherein the computer comprises a duplicator that analyzes characteristics of the recording and initiation of a procedure for verifying the conditions of duplication and control of etching of protected copies only when conditions of duplication associated with characteristics of the recording are valid.

20. The system according to claim 1, further comprising a controller comprising a base of identifiers and authorizations associated with the identifiers, which verification comprises verifying the state of authorizations corresponding to the identifier.

21. The system according to claim 20, wherein the identifiers are identifiers of at least a part of the original support.

22. The system according to claim 20, wherein the identifiers are identifiers of a proprietary user of the original support.

23. The system according to claim 22, wherein the identifier of the proprietary user of the original physical support is of the electronic signature type.

24. The system according to claim 22, wherein the identifier of the proprietary user of the original physical support is of the electronic address type.

25. The system according to claim 22, wherein the identifier of the proprietary user of said original physical support is of the mail type.

26. The system according to claim 20, wherein updating information modifies the state of an authorization computer.

27. The system according to claim 20, wherein the identifier of the original support is a single identifier associated with the physical support.

28. The system according to claim 21, wherein the identifier of the original support is an identifier of the computer that performed the first duplication.

29. The system according to claim 20, wherein the verification is performed automatically with the computer transmitting information for updating authorizations associated with the identifier after duplication directly to a server.

30. The system according to claim 20, wherein verification is not performed automatically, but a proprietary user of the original support transmits a key for updating authorizations.

31. The system according to claim 30, wherein the key is an identifier of the original support.

32. The system according to claim 30, wherein the key is an identifier of the proprietary user of the original support.

33. The system according to claim 30, wherein the key is a combination of an identifier of the original support and an identifier of the proprietary user of the original support.
